(19) United States
(12) Patent Application Publication
(10) Pub. No.: US 2025/0222532 A1
(43) Pub. Date: Jul. 10, 2025

(54) SOLDERING WIRES OF ELECTRODES TO TIN DOMES AND PADS IN A MULTIELECTRODE CATHETER

(71) Applicant: BIOSENSE WEBSTER (ISRAEL) LTD., Yokneam (IL)

(72) Inventors: Assaf Govari, Haifa (IL); Ilya Sitnitsky, Nahariya (IL); Alexander Shechtman, Haifa (IL); Nikolay Veits, Afula (IL); Sergey H. Sobol, Haifa (IL); Amit Fuchs, Hogla (IL)

(21) Appl. No.: 18/942,983

(22) Filed: Nov. 11, 2024

Related U.S. Application Data
(60) Provisional application No. 63/617,437, filed on Jan. 4, 2024.

(51) Int. Cl. B23K 1/00; B23K 3/08; B23K 101/38

(52) U.S. Cl. CPC B23K 1/0016; B23K 1/0004; B23K 3/087; B23K 2101/38

(57) ABSTRACT

A system includes: (I) a soldering assembly, including: (a) a joining tool, which is configured to: (i) press one or more wires against solder disposed over one or more pads, respectively, and (ii) heat the solder and the one or more wires; and (b) a spring, which is disposed between a movable stage and the joining tool, and is configured to press the joining tool against the one or more wires with an elastic force; and (II) a controller which is configured: (i) in a first step, to control a position of the movable stage relative to the joining tool for pressing the one or more wires against the solder, and (ii) in a second step, subsequent to the first step, to apply an electrical signal to the joining tool for heating the solder and the one or more wires and embedding the one or more wires in the solder.

### CROSS-REFERENCE TO RELATED APPLICATIONS

This application is related to U.S. Provisional Patent Application 63/617,437, filed Jan. 4, 2024, whose disclosure is incorporated herein by reference.

### FIELD OF THE DISCLOSURE

The present disclosure relates generally to medical devices, and particularly to methods and systems for soldering wires of electrodes to tin domes and pads in a multielectrode catheter.

### BACKGROUND OF THE DISCLOSURE

Some cardiac electrophysiological procedures require high-density mapping and/or tissue ablation using catheters having a large number of electrodes. For example, a basket catheter may have a plurality of splines, and a plurality of electrodes disposed on each of the plurality of splines, e.g., five-ten electrodes disposed on each spline. Each spline includes a dedicated pad electrically connected to one of the electrodes, and a dedicated wire running between the spline and connected to corresponding pad formed on a circuit board (CB) of a shaft of the catheter. The large number of pads and wires requires scaling down the pad size to tens of microns.

The present disclosure will be more fully understood from the following detailed description of the examples thereof, taken together with the drawings in which:

### BRIEF DESCRIPTION OF THE DRAWINGS

FIG. 1 is a schematic side view of a system and process steps for soldering a wire to a pad in a multielectrode catheter, in accordance with an example of the present disclosure;

FIG. 2 is a schematic side view of a joining tool implemented in the system of FIG. 1, in accordance with another example of the present disclosure; and

FIG. 3 is a flow chart that schematically illustrates a method for soldering wires to pads using the system of FIG. 1, in accordance with an example of the present disclosure.

### DETAILED DESCRIPTION OF EXAMPLES

### Overview

Some catheters, such as basket catheters, may have multiple electrodes mounted on a plurality of splines of the basket, which are coupled to wires extended along a length of a connector coupled to a distal end of a shaft of the catheter. Both the splines and the connector at the distal end have pads formed over circuit boards, and the catheter includes a plurality of wires, e.g., a wire for each electrode, running along the splines for connecting the electrodes to the connector. The wires of each spline may be arranged in braids or in any other configuration. The distal end of each wire is coupled to a predefined pad in the spline, and a proximal end of each wire is coupled to a corresponding pad in the connector, so as to exchange electrical signals between the electrodes and a control console of the catheter, via the connector. The large number of pads dictates a small dimension (e.g., tens of micrometers, also referred to herein as microns) of each pad on the circuit board, resulting in a time-consuming and costly coupling process between the wires and the respective pads. Moreover, each of the wires has a typical length between about one meter and two meters and a diameter between about 0.03 mm and 1 mm (e.g., a diameter of about 0.05 mm). Therefore, the wires are difficult to handle and are prone to damage. If there is a desire to solder a bunch of wires simultaneously (e.g., to improve the productivity and/or automation of the soldering process, it is difficult to simultaneously control the positioning of the multiple wires on the multiple respective pads. As such, at least one of the wires may undesirably move from its intended position, before or during the soldering.

Examples of the present disclosure that are described below provide techniques for improving the coupling between multiple (e.g., 10) wires of a multielectrode catheter, and respective pads, which are disposed on the circuit board (CB) of the catheter. In the context of the present disclosure and in the claims, the term substrate refers to the CB or to any other substrate having the pads disposed thereon. It is noted that in order to accommodate all the wires of the catheter within the CB, the size of each pad is reduced to tens of microns. In some examples, a solder is deposited over each of the pads, optionally followed by a reflow process for shaping the solder as multiple tin domes over the surface of the multiple pads, respectively. In other paste may be disposed over the pads, but the solder paste must have sufficiently high viscosity to prevent overflowing of the solder paste, and thereby, creating undesired electrical shorts between the pads. Subsequently, multiple wires are simultaneously disposed over the multiple tin domes, respectively, and each of the wires is soldered with a respective tin dome by heating the tin dome and the wire while urging or pressing the wire against the melted tin dome using a soldering system described herein.

In some examples, the system for soldering the wires to the tin domes and pads of the connector, comprises: (i) a soldering assembly having a joining tool and a spring connected to a controllable and movable stage, referred to herein as a Z-stage, whose structure and functionality are described in detail below, and (ii) a controller configured to control the soldering assembly in a two-step soldering process described herein. In other examples, the joining tool includes the spring and is stationary in the Z direction. Instead, the CB is mounted on the Z stage. In yet other examples, CB is mounted on an assembly including the spring and the Z stage.

In some examples, in the first step, the Z stage is configured to move the joining tool and/or the CB toward each other and thereby: (i) press the multiple wires against the multiple tin domes disposed over multiple pads with an elastic force, respectively, in the first step, and (ii) preheat the tin domes and the wires while further moving the joining tool and/or the CB toward each other. In some examples, the first step includes preheating tin dome to a first temperature. The preheating is carried out by a controller, which is configured to apply a first electrical pulse (also referred to herein as a first pulse of energy) to the joining tool. In response to the preheating and the elastic force applied by the spring, at least the tin domes are softened, so that: (i) the wires may be partially embedded into the tin domes, and (ii) all tin domes have approximately the same height. As such, the preheating improves the holding of the wires over the respective tin domes.

In some examples, the wires have an electrically insulating coating to prevent electrical shorts. In the second step, which is subsequent to the first step, the spring is urged in a compressed position, and the controller is configured to apply to the joining tool a second electrical pulse (also referred to herein as a second pulse of energy), having more energy compared to the first pulse. In response to the second electrical pulse, the temperature of the tin domes is further increased, resulting in further softening of the tin domes, to complete the soldering. Once the solder softens, the compressed spring is free to decompress and based on the passive decompression, the spring further urges the wire into the solder. This process provides gentle urging to avoid mechanical damage to the wires and/or the pads. In the present example, the joining tool is heated due to resistance of the material of the joining tool to the current of the first and second pulses applied by the controller. Moreover, the electrically insulating coating around the wires is melted and/or evaporated in the second step due to the heating of the solder. The heated solder that surrounds the wire provides the effect of removing the insulation and exposing the conductive part of the wire to the electrically conductive solder. This thermal-based removal of the insulating coating reduces the need to strip the insulating coating from each of the wires.

In some examples, the spring is disposed between the Z stage, and the joining tool. The spring is configured to elastically press the joining tool against the one or more wires intended to be soldered. The spring reduces the rigidity of the systems to accommodate for variabilities in the heights of the tin domes and thereby the pressure exerted on the wires. It is noted that in the absence of the spring, (i) excessive pressing between the joining tool and one or more of the tin domes may result in damaging (e.g., breaking or cracking) of the wires, and (ii) a gap between the joining tool and one or more of the tin domes may result in undesired movement of the wires with respect to the tin domes associated with the gap. Thus, by using the spring, the system is configured to compensate for variabilities in the heights, and control the force applied to the wires against the tin domes.

In some examples, in the first step, the controller associated with the Z stage is configured to (i) control the position of the joining tool relative to the pads with the wires therebetween, and (ii) apply the aforementioned first electrical pulse for preheating the wires and tin domes, so as to partially embed the wires into the respective tin domes, and thereby, improve the holding and positioning of the wires against the respective tin domes. In the second step, the controller is configured to apply the second electrical pulse to the joining tool for further heating and softening the tin domes and the respective wires, and at the same time, due to the softening of the tin domes, the spring is free to passively decompress, and thereby, to press the joining tool against the wires for fully inserting the wires into the respective tin domes.

In the present example, the second electrical pulse (also referred to herein as electrical signal) comprises an electrical pulse having an amplitude larger than about 100 watts (e.g., about 1.5 volts and about 100 amperes, resulting in about 150 watts), and a pulse width smaller than about 200 milliseconds (e.g., about 100 milliseconds). In some examples, the power of the second electrical pulse is approximately double, or quadruple compared to that of the first electrical pulse. In one implementation, the first and second electrical pulses may have the same amplitude, but a different pulse width of about 30 milliseconds and 100 milliseconds, respectively. In another implementation, the pulse width may be similar but the amplitude (i.e., voltage and/or current) may be different. In yet another example, both the pulse width and the pulse amplitude may be different.

In some examples, the tin domes are being softened due to the heating, and therefore, during the second step, the passive force applied by the spring is sufficient to fully embed the wires into the respective tin domes. When the wires are sufficiently close to the surface of the respective pads, the force applied to the wires is sufficiently small to prevent damaging the wires and the pads. As such, the elasticity of the spring is used as a damper to insert the wires into the respective tin domes without damaging the wires and/or the pads.

In some examples, in a third step which is carried out after concluding the first and second steps of the two-step soldering process, the controller is configured to control the movable stage to move away from the joining tool. Thus, the movable stage is configured to disengage the joining tool from the wires, and thereby, to prepare the system to receive the next set of wires intended to be placed over the next set of tin domes and pads, respectively. After concluding the third step, the system is configured to repeat the two-step soldering process described above.

The disclosed techniques enable fast and accurate soldering of wires to pads formed over the CB of at least the connector, and therefore, improve the quality and reduce the cost associated with the fabrication of such catheters. Moreover, the control scheme does not require a force sensor and/or measuring force, which simplifies the systems. Instead of force sensing the soldering process is controlled by controlling the distance between the stage and using the spring.

### SYSTEM DESCRIPTION

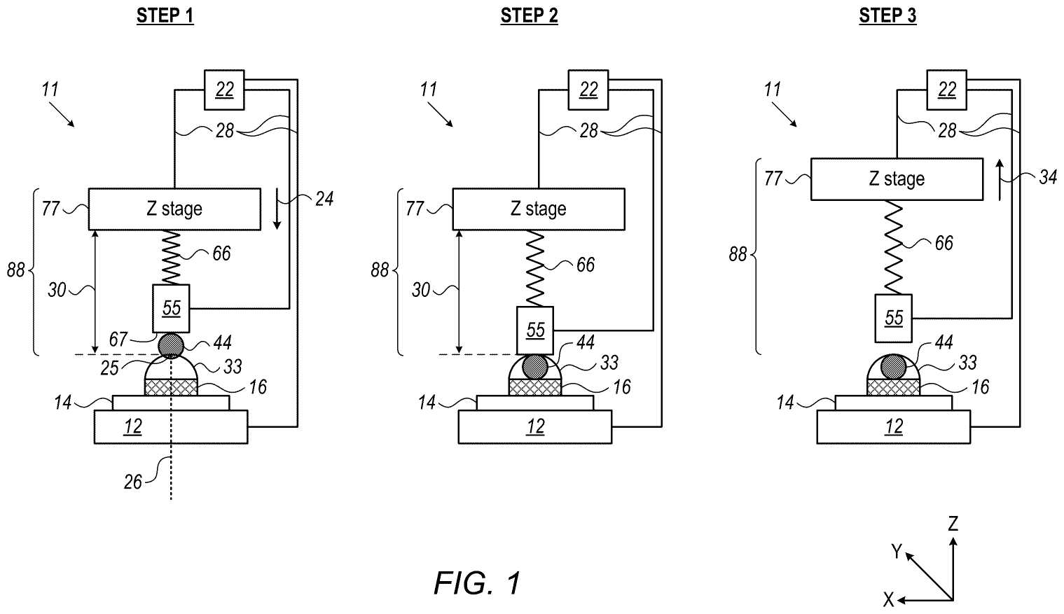

FIG. 1 is a schematic side view of a soldering system 11, in accordance with an example of the present disclosure.

In some examples, a circuit board (CB) 14 of a multielectrode catheter is placed over a suitable processing platform, e.g., a movable stage 12. The movable stage may include one or more of an X, Y and Z stage. The CB 14 has pads 16 formed on CB 14 and tin domes 33 formed over pads 16. In the present example, the tin domes 33 are formed over pads 16 by disposing a suitable type of tin (solder) or solder paste over each of the pads. Optionally when using solder, the CB may undergo a reflow process for shaping the solder as multiple tin domes 33 over the surface of the respective pads 16. The solder may comprise, for example, about 96.5% tin (Sn), about 3% silver (Ag), and about 0.5% copper (Cu), and may have a melting temperature between about 150° C. and 200° C. (e.g., about 177° C.). Such solder may include, for example, the LF318M series of products supplied by Harimatec Inc., a company of Harima Chemicals Group Inc. (Duluth, GA 30096). In other examples, tin domes 33 may be formed over pads 16 using any other suitable type of solder and/or any other suitable type of process.

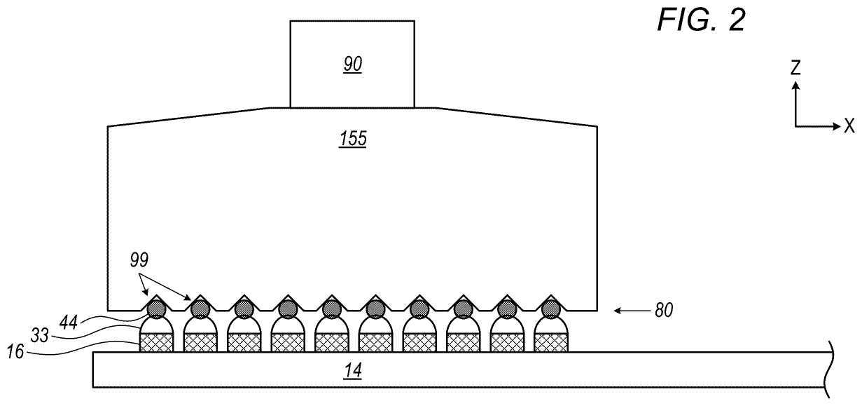

In some examples, system 11 is configured to solder one or more wires 44 to tin domes 33 disposed over pads 16. In the present example, system 11 includes a soldering assembly 88 comprising (i) a joining tool 55 that in the present example has a smooth joining surface 67 (but may have any other suitable surface as shown for example in FIG. 2 below), (ii) a spring 66, and (iii) a Z stage 77 (also referred to herein as a stage for brevity) configured to move along a Z-axis of an XYZ coordinate system. The structure and functionality of the components of soldering assembly 88 are described in detail below.

In some examples, system 11 further comprises a controller 22, which is configured to control the components of soldering assembly 88 in a multi-step soldering process described herein. For the sake of conceptual clarity, in the example of FIG. 1 the multi-step process is applied to a single wire 44, which is soldered to a respective pad 16. It is noted that the same techniques may be applied, mutatis mutandis, to system 11 for soldering multiple pairs of wires 44 and pads 16 at the same time.

Reference is now made to a step 1 (also referred to herein as a first step) of the soldering process. One end of wire 44, which has a length between about 1 meter and 2 meters, is placed over the upper surface of tin dome 33 at a position 25 that falls on an axis 26 parallel to the Z-axis. Due to the small diameter and inherent flexibility of wire 44, wire 44 may undesirably move away from position 25 along the surface of tin dome 33 even though it is held from opposite ends. This is particularly the case when simultaneously handing a plurality of wires 44 and simultaneously pressing the plurality of wires 44 against the respective pads 16.

In some examples, each wire 44 is held against a respective pad 16 with a pair of graspers (not shown) configured to hold wires 44 from opposite ends of pads 16. In an example implementation, a single pair of graspers is configured to hold all wires 44 from opposite ends of the respective pads 16. One implementation of such graspers is described in detail, for example, in U.S. Provisional Patent Application 63/608,872, whose disclosure is incorporated herein by reference. In other examples, system 11 may comprise any other suitable type of graspers or grippers configured to hold multiple wires 44 over multiple tin domes 33 and pads 16, respectively.

In some examples, in step 1 controller 22 is configured to control stage 77 (e.g., via cables 28) to move a predefined distance in a direction 24 along the Z axis. The movement in direction 24 is carried out in order to set the location of stage 77 at a predefined distance 30 from position 25 on the surface of tin dome 33. Position 25 may be determined in relation to stage 12. The positioning of stage 77 at distance 30 is carried out in order to (i) place joining tool 55 in contact with wire 44 to press wire 44 against tin dome 33 at position 25, and (ii) compress spring 66 so that joining tool 55 is pressed against wire 44. It is noted that in the compressed position, spring 66 is configured to apply a given force to joining tool 55 in direction 24. In the present example, stage 12 is also connected to and controlled by controller 22 via cables 28 in order carry out operations described below. It is noted that in such examples, the graspers are holding the multiple wires 44 over the multiple tin domes 33 and pads 16, respectively, and based on the position of Z stage 77 and the elastic force applied by spring 66, joining tool 55 is pressing wires 44 against tin domes 33 and pads 16.

In the example configuration of system 11, spring 66 comprises any suitable product selected from the LC 026D family of products supplied by Lee spring company (140 58^{th} St. unit 3C, Brooklyn NY 11220). As such, spring 66 is made from stainless steel 316, having a spring constant between about 0.05 Kg/mm (i.e., about 0.49 N/mm) and 0.2 Kg/mm (i.e., about 1.96 N/mm), and configured to apply force at the compressed position.

In one example implementation, in the compressed position or state of spring 66 is configured to apply to joining tool 55 a force between about 0.05 N and 0.2 N or any other suitable force. In some examples, the force measurement is not required during the soldering process. In such examples, a calibration step may be carried out before conducting the soldering process. In the calibration step, distance 30 is calibrated to obtain the required suitable force described above.

In some examples, controller 22 is configured to apply a first electrical pulse (also referred to herein as a first pulse of energy) to joining tool 55. The electrical pulse may have, for example, an amplitude of about 150 watts and a pulse width of about 30 milliseconds or 50 milliseconds. Joining tool 55 is heated due to intrinsic resistance thereof to the current of the first pulse applied by controller 22. The heat formed in joining tool 55 is transferred to wires 44 and tin domes 33 and resulting in softening thereof, and simultaneously, spring 66 applies the force to joining tool 55. The simultaneous (i) heating of wires 44 and tin domes 33, and (ii) pressing joining tool 55 against wires 44, causes a portion (e.g., between about 5% and 20%) of wires 44 to be embedded into tin domes 33, respectively. The partial embedding improves the ability of joining tool 55 to stabilize wires 44 at position 25? on the surface of tin domes 33, respectively.

Reference is now made to step 2 (also referred to herein as a second step) of the soldering process, which is subsequent to step 1. In the present example, joining tool 55 is shaped to stabilize wire 44 against tin domes 33 with an elastic force. In some examples, in step 2 controller 22 is configured to: (i) heat tin dome 33 and wire 44 by applying, via cables 28, an electrical signal to joining tool 55, and at the same time, (ii) the energy stored in spring 66 from its compressed state is released and continues to press joining tool 55 against wire 44 in order to press wire 44 into the respective tin dome 33. During step 2, Z stage 77 is stationary and the movement between joining tool 55 and pad 16 is based on decompression of spring 66.

In the present example, the electrical signal comprises an electrical pulse (also referred to herein as a second electrical pulse) having an amplitude larger than about 100 watts (e.g., about 1.5 volts and about 100 amperes, resulting in about 150 watts), and a pulse width smaller than about 200 milliseconds (e.g., about 100 milliseconds).

In some examples, in step 2, while pressing joining tool 55 against wire 44, spring 66 is elongated relative to step 1. As described in step 1 above, controller 22 is configured to set distance 30 between stage 77 and tin dome 33, such that at the final stage of step 2 spring 66 is elongated but still applies a force similar to that of step 1 above. It is noted that tin dome 33 is softened due to the heating carried out in step 2. Therefore, in step 2 the force applied by spring 66 is sufficient to embed wire 44 into tin dome 33. Subsequently, when the wire 44 (which is inserted into tin dome 33) is sufficiently close to the surface of pad 16, the force applied by spring 66 is sufficiently small to prevent damage to wires 44 and pads 16. Moreover, it is noted that in order to prevent damage to wires 44 and/or pads 16, stage 77 is not being moved during step 2, and the elasticity of spring 66 is used as a damper to insert the wire 44 into tin dome 33, but without damaging tin dome 33 and pad 16.

In some examples, wires 44 have an electrically insulating coating, made from polyimide, polyurethane, or any other suitable material. In response to the application of the second electrical pulse, wires 44 are being heated by the solder of tin domes 33 (that surrounds wires 44) to a temperature larger than about 150° C., and thereby, melt and remove the electrically insulating coating.

Reference is now made to a step 3 (also referred to herein as a third step), which is carried out at the end of the soldering process described in steps 1 and 2 above. In step 3, controller 22 is configured to control stage 77 to move in a direction 34 (typically parallel to the Z-axis) away from joining tool 55. As such, stage 77 is configured to disengage joining tool 44 from wire 44 (and tin dome 33), and the length of spring 66 is approximately the equilibrium length. After concluding step 3, CB 14 may be moved relative to soldering assembly 88, e.g., along the X-axis, so as place soldering assembly 88 in front of one or more new pads 16 and tin dome 33 as shown and described in detail in step 1 above. In other words, after concluding step 3, system 11 is configured to repeat steps 1 and 2 of the soldering process described above. It is noted that steps 1, 2 and 3 are controlled by controller 22 and are carried out automatically. Moreover, the relative movement between CB 14 and soldering assembly 88 is controlled by controller 22 and may be carried out by moving (i) soldering assembly 88, or (ii) CB 14, along the X-axis. For example, stage 12 may comprise an XY stage, which is controlled by controller 22 and is configured to move CB 14 relative to soldering assembly 88 along the X- and Y-axes, so as to place soldering assembly 88 in front of a new set of one or more pads 16 and one or more tin domes 33, respectively, as shown and described in detail in step 1 above for a single wire 44, tin dome 33 and pad 16, and in FIG. 2 below for multiple wires 44, tin domes 33 and pads 16 soldered simultaneously. Moreover, as described above, the techniques disclosed FIG. 1 may be applied, mutatis mutandis, to system 11 for soldering multiple sets of wires 44, tin domes 33, and pads 16 at the same time. In other examples, the movement along the X-axis may be carried out to perform the soldering process on an additional CB 14.

In alternative examples, the configuration of system 11 may comprise a static plate instead of stage 12, and stage 77 may also be configured to move along the X- and Y-axes to enable the relative movement between soldering assembly 88 and CB 14.

This particular configuration of system 11 is shown by way of example, in order to illustrate certain problems that are addressed by examples of the present invention and to demonstrate the application of these examples in enhancing the performance of such a soldering system. Examples of the present invention, however, are by no means limited to this specific sort of example system, and the principles described herein may similarly be applied to other sorts of soldering systems. Moreover, the properties of tin dome 33 are provided by way of example, and the disclosed techniques are applicable, mutatis mutandis, to other sorts of solder (or other suitable materials) and/or geometries other than that of tin dome 33.

In some examples, joining tool 55 may have a jagged surface, which is suitable for aligning and stabilizing one or more wires 44 against one or more pads 16 and tin domes 33 (or other solder), respectively. Moreover, the joining tool may optionally have a different size compared to that of joining tool 55. An example implementation of such a joining tool is presented in FIG. 2 below.

FIG. 2 is a schematic side view of a joining tool 155, in accordance with another example of the present disclosure. Joining tool 155 may replace, for example, joining tool 55 of FIG. 1 above with the smooth joining surface 67.

In some examples, joining tool 155 has a jagged surface 80, also referred to herein as a teeth-shaped surface, which is configured to press (and optionally hold) one or more wires 44, in the present example about ten wires 44, to carry out the soldering process described in FIG. 1 above. In the present example, surface 80 has ten V-shaped recesses 99, each recess 99 is configured to press a single wire 44 intended to be soldered to a respective tin dome 33, as described in detail in FIG. 1 above. It is noted that the smooth joining surface 67 of joining tool 55 has no recesses, and surface 67 is typically flat without any protrusions or intrusions.

In the example of FIG. 2, joining tool 155 is in the position of step 1 of FIG. 1 above, and the V shape of recess 99 improves the ability of joining tool 155 to align and stabilize wires 44 being held over the ten tin domes 33, respectively. The distances between the apex of the V shape recesses are defined based on a known distance of the pads on CB 14. Optionally, assembly 11 may include different size and shaped joining tools to accommodate different arrangements of pads 16 on CB 14. In other examples, instead of V shape, recesses 99 may have any other shape suitable for (i) stabilizing and aligning wires 44 as described in step 1 of FIG. 1 above, and subsequently, (ii) embedding wires 44 into tin domes 33, as described in step 2 of FIG. 1 above.

In some examples, while pressing wires 44 against tin domes 33, controller 22 is configured to apply the preheating electrical pulse (also referred to herein as the first electrical pulse) to joining tool 155 for preheating tin domes 33 and have a portion of wires 44 inserted into or embedded in tin domes 33, as described in FIG. 1 above. In some examples, joining tool 155 comprises a housing 90, which is configured to contain at least a portion of spring 66 shown in FIG. 1 above.

This particular configuration of joining tool 155 is shown by way of example, in order to illustrate certain problems that are addressed by examples of the present invention and to demonstrate the application of these examples in enhancing the performance of such a soldering system. Examples of the present invention, however, are by no means limited to this specific sort of example joining tool and soldering system, and the principles described herein may similarly be applied to other sorts of soldering systems.

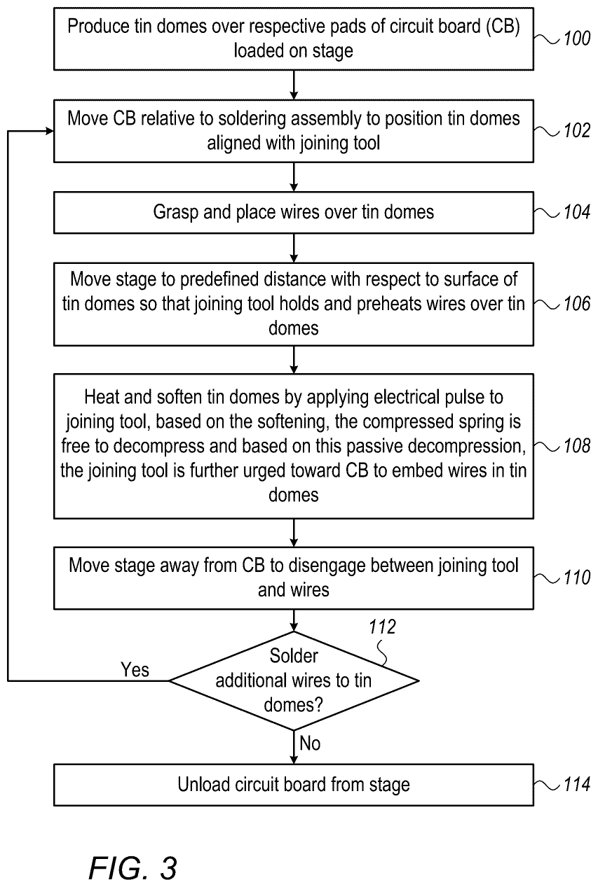

FIG. 3 is a flow chart that schematically illustrates a method for soldering one or more wires 44, tin domes 33 and pads 16 using system 11, in accordance with an example of the present disclosure.

The method begins at a tin dome formation step 100 with disposing solder over one or more pads 16, and applying a reflow process for shaping the solder into one or more tin domes 33, respectively, as described in detail in FIG. 1 above. In some examples, step 100 is carried out by the manufacturer of the catheter. In other examples, step 100 may be carried out by a subcontractor, and in such examples, step 100 may comprise receiving CB 14 with the solder, such as tin domes 33, disposed over pads 16.

At a first XY movement step 102, controller 22 controls one or both of stages 12 and 77 to position the one or more tin domes 33 (formed in step 100 above) aligned with joining tool 55 along axis 26, the alignment may be controlled, for example, based on images or video acquired using a suitable camera.

At a wire positioning step 104, one or more wires 44 are being grasped using a pair of graspers. Subsequently, the one or more wires 44 are aligned between the graspers over the respective one or more tin domes 33 and pads 16, so that that the one or more wires 44 are placed over one or more tin domes 33, respectively.

At a first Z movement step 106, controller 22 controls stage 77 to move in direction 24 and to position joining tool 55 in contact with one or more wires 44, so as to press the one or more wires 44 along axis 26 over the surface of tin domes 33, respectively. At least some of the operation of steps 104 and 106 may be carried out simultaneously. As shown in step 1 of FIG. 1 above, controller 22 controls stage 77 to move in direction 24 along the Z-axis in order to set the location of stage 77 at distance 30 from position 25 on the surface of tin dome 33. At distance 30, spring 66 is compressed, and thereby, is elastically urged against wire 44 and tin dome 33. In alternative examples, the spring 66 may be integrated with stage 12 in order to press joining tool 55 against wires 44 and tin domes 33.

Moreover, at the same time, controller 22 applies the aforementioned first electrical pulse to the joining tool (e.g., joining tool 55 of FIG. 1 above, or joining tool 155 of FIG. 2 above) for preheating wires 44 and tin domes 33, so as to partially embed wires 44 into the respective tin domes 33, and thereby, press wires 44 firmly against the respective tin domes 33, as described in detail in FIGS. 1 and 2 above. It is noted that after concluding step 106, soldering assembly 88 and CB 14 are positioned as shown in step 1 of FIG. 1 above.

At a heating step 108, controller 22 applies, via cables 28, the second electrical pulse (larger than the first electrical pulse of step 106 above) having the amplitude of about 150 watts, and the pulse width of about 100 milliseconds for heating tin domes 33 and respective wires 44. As described in detail in FIG. 1 above, the heating is carried out while, at the same time, spring 66 continues to press joining tool 55 against wire 44. The heating softens tin domes 33, and based on the softening of tin domes 33, the compressed spring 66 is free to decompress, and based on this passive decompression, the joining tool 55 is further urged toward CB 14. As such, the one or more wires 44 are being fully embedded in the one or more tin dome 33, respectively, as shown and described in detail in step 2 of FIG. 1 above. It is noted that, after concluding step 108, the one or more wires 44 are soldered to one or more tin domes 33, respectively.

At a second Z movement step 110, controller 22 controls stage 77 to move in direction 34, so as to disengage between joining tool 55 of FIG. 1 above (or joining tool 155 of FIG. 2 above), and one or more wires 44, as described in detail in step 3 of FIG. 1 above.

At a decision step 112, controller 22 checks whether or not one or more additional wires 44 are intended to be soldered to additional one or more tin domes 33, respectively.

In case additional wires 44 are intended to be soldered to additional one or more tin domes 33, respectively, the method loops back to step 102.

In case no additional wires 44 are intended to be soldered, the method proceeds to an unloading step 114 that concludes the method by unloading CB 14 from stage 12.

Although the examples described above mainly address precise soldering of wires to pads of a circuit board on a connector of a catheter, the methods and systems described herein can also be used in other applications, such as in soldering wires to the splines of a multielectrode catheter or in any other fabricating process of catheters or other parts of a medical system that require a deep sub-millimeter precision level.

### Example 1

A system (11) includes: (I) a soldering assembly (88), including: (a) a joining tool (55, 155), which is configured to: (i) press one or more wires (44) against solder (33) disposed over one or more pads (16), respectively, and (ii) heat the solder (33) and the one or more wires (44); and (b) a spring (66), which is disposed between a movable stage (77) and the joining tool (55, 155), and is configured to press the joining tool (55, 155) against the one or more wires (44) with an elastic force; and (II) a controller (22) which is configured: (i) in a first step, to control a position of the movable stage (77) relative to the joining tool (55, 155) for pressing the one or more wires (44) against the solder, and (ii) in a second step, subsequent to the first step, to apply an electrical signal to the joining tool (55, 155) for heating the solder (33) and the one or more wires (44), and embedding the one or more wires (44) in the solder (33).

### Example 2

The system according to Example 1, wherein in the first step, the controller is configured to apply a preheating electrical pulse to the joining tool, wherein, in response to applying the preheating electrical pulse, the solder is heated and softened to a degree that enables the one or more wires to be partially embedded into the solder based on the elastic force applied by the spring.

### Example 3

The system according to Example 2, wherein the solder includes one or more dome shapes formed over the one or more pads, respectively, and wherein: (i) in the first step, the joining tool is configured to partially embed the one or more wires into the solder for pressing the one or more wires against the one or more dome shapes, respectively, and (ii) in the second step, the soldering assembly is configured to fully embed the one or more wires in the one or more dome shapes, respectively.

### Example 4

The system according to Example 2, wherein the preheating electrical pulse has an amplitude larger than 100 watts and a width smaller than 100 milliseconds.

### Example 5

The system according to Example 2, wherein in a third step, which is subsequent to the second step, the controller is configured to control the movable stage to move away relative to the joining tool, to disengage the joining tool from the one or more wires.

### Example 6

The system according to Example 1, wherein the joining tool is configured to heat the solder in response to receiving the electrical signal from the controller, and wherein the electrical signal includes an electrical pulse having an amplitude larger than 100 watts and a width smaller than 200 milliseconds.

### Example 7

The system according to Example 1, wherein in the first step, the controller is configured to compress the spring based on the position of the movable stage, and in the second step, the heating is softening the solder, and the spring is configured to decompress for embedding the one or more wires into the solder.

### Example 8

The system according to Example 1, wherein the joining tool has a jagged surface, which is configured to press the one or more wires against the solder.

### Example 9

The system according to Example 8, wherein the jagged surface includes one or more v shaped recesses configured to align and stabilize the one or more wires, respectively, against the solder.

### Example 10

The system according to Example 1, wherein the joining tool has a flat surface, which is configured to press the one or more wires against the solder.

### Example 11

A method for soldering, the method includes receiving a circuit board (CB) including one or more pads, and solder disposed over the one or more pads. The CB is moved relative to a soldering assembly that includes: (a) a joining tool for (i) pressing one or more wires against the solder, and (ii) heating the solder and the one or more wires; and (b) a spring for pressing the joining tool against the one or more wires with an elastic force. In a first step, a position of a movable stage is controlled relative to the joining tool for pressing the one or more wires against the solder in a first step, and in a second step, subsequent to the first step, an electrical signal is applied to the joining tool for heating the solder and the one or more wires, and embedding the one or more wires in the solder.

It will be appreciated that the examples described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present only specification, the definitions in the present specification should be considered.

1. A system, comprising:
a soldering assembly, comprising:
a joining tool, which is configured to: (i) press one or more wires against solder disposed over one or more pads, respectively, and (ii) heat the solder and the one or more wires; and
a spring, which is disposed between a movable stage and the joining tool, and is configured to press the joining tool against the one or more wires with an elastic force; and
a controller which is configured: (i) in a first step, to control a position of the movable stage relative to the joining tool for pressing the one or more wires against the solder, and (ii) in a second step, subsequent to the first step, to apply an electrical signal to the joining tool for heating the solder and the one or more wires, and embedding the one or more wires in the solder.

2. The system according to claim 1, wherein in the first step, the controller is configured to apply a preheating electrical pulse to the joining tool, wherein, in response to applying the preheating electrical pulse, the solder is heated and softened to a degree that enables the one or more wires to be partially embedded into the solder based on the elastic force applied by the spring.

3. The system according to claim 2, wherein the solder comprises one or more dome shapes formed over the one or more pads, respectively, and wherein: (i) in the first step, the joining tool is configured to partially embed the one or more wires into the solder for pressing the one or more wires against the one or r more dome shapes, respectively, and (ii) in the second step, the soldering assembly is configured to fully embed the one or more wires in the one or more dome shapes, respectively.

4. The system according to claim 2, wherein the preheating electrical pulse has an amplitude larger than 100 watts and a width smaller than 100 milliseconds.

5. The system according to claim 2, wherein in a third step, which is subsequent to the second step, the controller is configured to control the movable stage to move away relative to the joining tool, to disengage the joining tool from the one or more wires.

6. The system according to claim 1, wherein the joining tool is configured to heat the solder in response to receiving the electrical signal from the controller, and wherein the electrical signal comprises an electrical pulse having an amplitude larger than 100 watts and a width smaller than 200 milliseconds.

7. The system according to claim 1, wherein in the first step, the controller is configured to compress the spring based on the position of the movable stage, and in the second step, the heating is softening the solder, and the spring is configured to decompress for embedding the one or more wires into the solder.

8. The system according to claim 1, wherein the joining tool has a jagged surface, which is configured to press the one or more wires against the solder.

9. The system according to claim 8, wherein the jagged surface comprises one or more v shaped recesses configured to align and stabilize the one or more wires, respectively, against the solder.

10. The system according to claim 1, wherein the joining tool has a flat surface, which is configured to press the one or more wires against the solder.

11. A method for soldering, the method comprising:
receiving a circuit board (CB) comprising one or more pads, and solder disposed over the one or more pads;
moving the CB relative to a soldering assembly, comprising: (a) a joining tool for (i) pressing one or more wires against the solder, and (ii) heating the solder and the one or more wires; and (b) a spring for pressing the joining tool against the one or more wires with an elastic force;
in a first step, controlling a position of a movable stage relative to the joining tool for pressing the one or more wires against the solder in a first step; and
in a second step, subsequent to the first step, applying an electrical signal to the joining tool for heating the solder and the one or more wires, and embedding the one or more wires in the solder.

12. The method according to claim 11, and comprising applying a preheating electrical pulse to the joining tool, for heating and softening the solder to a degree that enables the one or more wires to be partially embedded into the solder based on the elastic force applied by the spring.

13. The method according to claim 12, wherein the solder comprises one or more dome shapes formed over the one or more pads, respectively, and wherein: (i) in the first step, partially embedding the one or more wires into the solder, in response to applying the preheating electrical pulse and pressing the one or more wires against the one or more dome shapes, respectively, and (ii) in the second step, fully embedding the one or more wires in the one or more dome shapes, respectively, in response to applying the electrical signal to the joining tool.

14. The method according to claim 12, wherein applying the preheating electrical pulse comprises applying the preheating electrical pulse having an amplitude larger than 100 watts and a width smaller than 100 milliseconds.

15. The method according to claim 12, wherein in a third step, which is subsequent to the second step, controlling the movable stage to move away relative to the joining tool, to disengage the joining tool from the one or more wires.

16. The method according to claim 11, wherein applying the electrical signal comprises applying an electrical pulse having an amplitude larger than 100 watts and a width smaller than 200 milliseconds.

17. The method according to claim 11, wherein controlling the position of the movable stage comprises compressing the spring, and in the second step, the heating is softening the solder, and the spring is decompressing for embedding the one or more wires into the solder.

18. The method according to claim 11, wherein the joining tool has a jagged surface for pressing the one or more wires against the solder.

19. The method according to claim 18, wherein the jagged surface comprises one or more v shaped recesses for aligning and stabilizing the one or more wires, respectively, against the solder.

20. The method according to claim 11, wherein the joining tool has a flat surface for pressing the one or more wires against the solder.
